(19) United States
(12) Patent Application Publication
(10) Pub. No.: US 2026/0303645 A1
(43) Pub. Date: Oct. 1, 2026

(54) METHODS AND SYSTEMS FOR INTERNET OF THINGS (IOT) VULNERABILITY DETECTION BASED ON LARGE LANGUAGE MODEL-ASSISTED REASONING

(71) Applicant: HUAZHONG UNIVERSITY OF SCIENCE AND TECHNOLOGY, Wuhan, Hubei (CN)

(72) Inventors: Bin YUAN, Wuhan (CN); Zhenyu LU, Wuhan (CN); Qiankun ZHANG, Wuhan (CN); Yudi WANG, Wuhan (CN); Zhanxiang SONG, Wuhan (CN); Deqing ZOU, Wuhan (CN); Yong LIU, Wuhan (CN)

(73) Assignee: HUAZHONG UNIVERSITY OF SCIENCE AND TECHNOLOGY, Wuhan (CN)

(21) Appl. No.: 19/246,817

(22) Filed: Jun. 24, 2025

(30) Foreign Application Priority Data
Mar. 27, 2025 (CN) 202510376739.0

(51) Int. Cl. H04L 9/40

(52) U.S. Cl. CPC H04L 63/1433

(57) ABSTRACT

Provided are a method and a system for IoT vulnerability detection based on LLM-assisted reasoning. The method comprises: connecting a test module to a test environment; defining a security attribute for testing based on a test objective; designing and synthesizing a prompt for an LLM based on the security attribute; invoking the LLM via the test module based on the prompt, autonomously executing the testing under guidance of the LLM, and using a log to record an input and an output of the LLM during the testing; and analyzing a test result based on the output of the LLM during the testing, verifying authenticity and validity of a vulnerability based on the test result and the log during the testing. The system includes an upper-layer router, a test host, and a test environment, and the test environment includes vulnerability detection.

### CROSS REFERENCE TO RELATED APPLICATIONS

This application claims priority to Chinese Patent Application No. 202510376739.0, filed on Mar. 27, 2025, the entire contents of which are incorporated herein by reference.

### TECHNICAL FIELD

The present disclosure relates to the field of IoT security technologies, and in particular, to a method and a system for IoT vulnerability detection based on large language model-assisted reasoning.

### BACKGROUND

Currently, IoT vulnerability detection employs Fuzzing-based testing techniques, which involve inputting random or semi-random data into a target system to identify potential vulnerabilities in modules. The core idea is to trigger module errors through abnormal inputs, thereby revealing security vulnerabilities. However, this approach is designed for device firmware and can only test firmware vulnerabilities. Additionally, Fuzzing testing is generally inefficient.

Therefore, there is a need to provide a method and a system for IoT vulnerability detection based on large language model-assisted reasoning. By leveraging a reasoning capability of a large language model (LLM), the method comprehensively tests potential vulnerabilities in an IoT system, particularly logic-related vulnerabilities, thereby automating the detection and identification of logical vulnerabilities. The method offers broader test coverage and higher efficiency in vulnerability detection.

### SUMMARY

One or more embodiments of the present disclosure provide a method for Internet of Things (IoT) vulnerability detection based on large language model (LLM)-assisted reasoning, comprising: connecting a test module to a test environment, which includes: connecting, via the test module running on a test host, the test module to a client in the test environment using an Android Debug Bridge (ADB) utility class, connecting the test module to a lower-layer router in the test environment using a Secure Shell (SSH) client, and connecting the test module to a device monitoring and control apparatus using a serial interface. The method further comprises: defining a security attribute for testing based on a test objective, including: determining the test objective before the testing begins, and describing the test objective for performing the test and the security attribute using a natural language; designing and synthesizing a prompt for an LLM based on the security attribute, including: generating a runtime prompt based on a prompt template and the security attribute; invoking the LLM via the test module based on the prompt, autonomously executing the testing under guidance of the LLM, and using a log to record an input and an output of the LLM during the testing; and analyzing a test result based on the output of the LLM during the testing, verifying authenticity and validity of a vulnerability based on the test result and the log during the testing.

One or more embodiments of the present disclosure provide a system for Internet of Things (IoT) vulnerability detection based on large language model (LLM)-assisted reasoning, comprising: an upper-layer router, a test host, and a test environment. The upper-layer router is configured to provide network connectivity for an entire detection system. The test host is configured to run a test module. The test module is configured to: invoke an API of the LLM over a network to utilize a reasoning capability of the LLM, and autonomously determine test execution steps based on the reasoning capability of the LLM. The test environment includes a lower-layer router, an IoT device, a client, and a device monitoring and control apparatus. The lower-layer router is a network control hub and configured to simulate a home environment of an IoT user in a Wi-Fi router. The lower-layer router is connected to the upper-layer router to provide network connectivity and a unified simulated network environment for the IoT device and the client. The test environment simulates a scenario in which the IoT user uses the IoT device. The IoT device is a device under test (DUT) and configured to simulate the IoT device of the IoT user. The client is configured to run an IoT application module corresponding to the DUT and simulate a user terminal of the IoT user.

### BRIEF DESCRIPTION OF THE DRAWINGS

The present disclosure will be further illustrated by way of exemplary embodiments, which will be described in detail by means of drawings. These embodiments are non-limiting exemplary embodiments, in which same reference numerals represent same structures, wherein:

FIG. 1 is an exemplary schematic diagram illustrating a system for Internet of Things (IoT) vulnerability detection based on large language model (LLM)-assisted reasoning according to some embodiments of the present disclosure;

FIG. 2 is a schematic diagram illustrating connections between a test module and a test environment according to some embodiments of the present disclosure;

FIG. 3 is a flowchart illustrating an exemplary process for IoT vulnerability detection based on LLM-assisted reasoning according to some embodiments of the present disclosure; and

FIG. 4 is a schematic diagram illustrating connections between elements of a system for IoT vulnerability detection based on LLM-assisted reasoning according to some embodiments of the present disclosure.

### DETAILED DESCRIPTION

In order to more clearly illustrate the technical solution of the embodiments of the present disclosure, the drawings required to be used in the description of the embodiments are briefly described below. Obviously, the drawings in the following description are only some examples or embodiments of the present disclosure, and it is possible for those skilled in the art to apply the present disclosure to other similar scenarios according to these drawings without creative labor. Unless obviously obtained from the context or the context illustrates otherwise, same reference numerals in the drawings represent same structures or operations.

It should be understood that the terms “system,” “device,” “unit,” and/or “module” as used herein is a way to distinguish between different components, elements, parts, sections or assemblies at different levels. However, these words may be replaced by other expressions if other words accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate operations performed by a system according to embodiments of the present disclosure. It should be understood that the preceding or following operations are not necessarily performed in an exact sequence. Instead, operations may be processed in reverse order or simultaneously. Also, it is possible to add other operations to these processes or remove one or more operations from these processes.

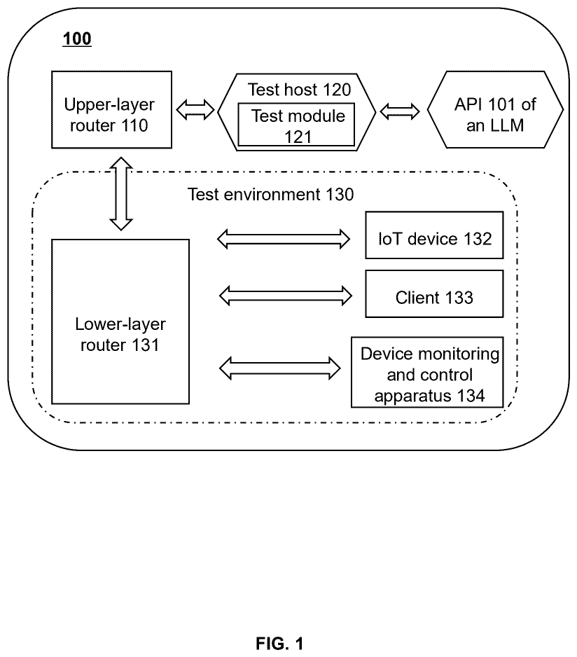

Some embodiments of the present disclosure provide a system for Internet of Things (IoT) vulnerability detection based on large language model (LLM)-assisted reasoning. FIG. 1 is an exemplary schematic diagram illustrating a system for Internet of Things (IoT) vulnerability detection based on large language model (LLM)-assisted reasoning according to some embodiments of the present disclosure. The following embodiments may be understood with reference to FIG. 1, but the drawing is only an illustration of some connections and does not constitute a limitation on the connection relationships.

In some embodiments, as shown in FIG. 1, a system 100 for IoT vulnerability detection based on LLM-assisted reasoning (hereinafter referred to as the system 100) includes an upper-layer router 110, a test host 120, and a test environment 130.

The upper-layer router 110 is a core router that provides network connectivity. The upper-layer router 110 may be a wide area network (WAN) router, an enterprise-grade router, or the like.

In some embodiments, the upper-layer router 110 is configured to provide network connectivity for the entire detection system (e.g., the system 100).

The test host 120 is a computer or a server configured to perform vulnerability detection. In some embodiments, the test host 120 is configured to run a test module 121.

The test module 121 may include a processor or the like. The processor may be a microcontroller (MCU), an embedded processor, a graphics processing unit (GPU), or the like, or any combination thereof.

In some embodiments, the system 100 further includes a large language model (LLM). In some embodiments, the test module 121 is configured to invoke an application programming interface (API) 101 of the LLM over a network, thereby leveraging a reasoning capability of the LLM to autonomously determine steps for performing testing.

In some embodiments, the LLM may be Generative Pre-trained Transformer (GPT), Bidirectional Encoder Representations from Transformers (BERT), Text-to-Text Transfer Transformer (T5), Pathways Language Model (PaLM), LLM Meta AI (LLAMA), or the like.

The API 101 of the LLM refers to an interface for accessing and invoking the LLM. Through the API 101 of the LLM, a developer may integrate the reasoning capability of the LLM without directly training or deploying the LLM.

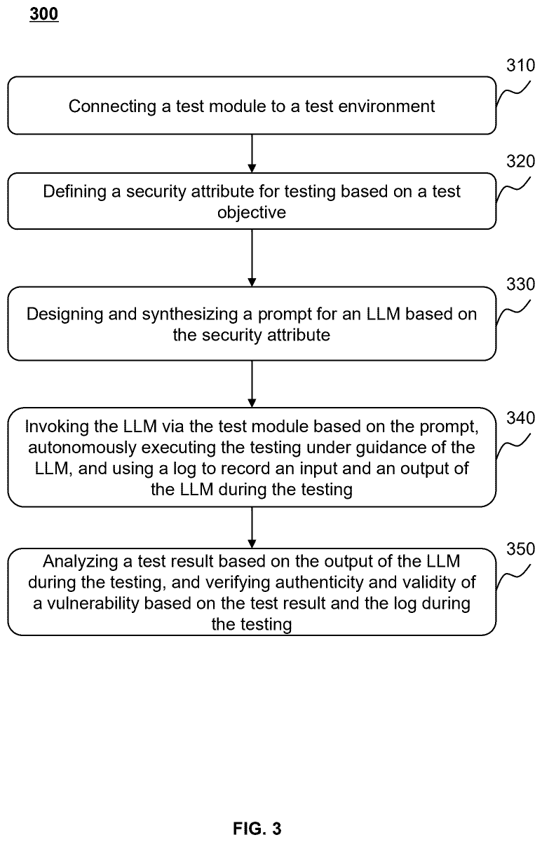

The steps for testing refer to the steps executed by the test module 121 to implement testing functions. For specific details, refer to FIG. 3 and related descriptions.

The test environment 130 is a foundational platform for vulnerability detection.

In some embodiments, the test environment 130 may include a lower-layer router 131, an IoT device 132, a client 133, and a device monitoring and control apparatus 134. The lower-layer router 131 acts as a network control hub and is configured to simulate a Wi-Fi router in a home environment of an IoT user. The lower-layer router 131 is connected to the upper-layer router 110, providing network connectivity and a unified simulated network environment for the IoT device 132 and the client 133. The test environment 130 simulates scenarios where the IoT user utilizes the IoT device 132.

The lower-layer router 131 is a router that connects the client 133 to an upper-layer network. The lower-layer router 131 may be a home router, a small business router, or the like.

The IoT user is a user who utilizes the IoT device.

The IoT device 132 refers to a physical device that connects, interacts, and exchanges data via the Internet or other communication networks. The IoT device 132 may include a smart home device (e.g., a smart bulb, a smart speaker, etc.), an industrial IoT device (e.g., an industrial sensor, an equipment monitoring system, etc.), a smart city device (e.g., a smart streetlight, an environmental monitoring device, etc.), a healthcare device (e.g., a wearable device, a remote medical device, etc.), or the like.

In some embodiments, the IoT device 132 is a device under test (DUT) and is configured to simulate an IoT device used by the IoT user. The DUT is an IoT device that requires vulnerability detection.

The client 133 refers to a simulated device in the system 100 that communicates with a server and requests services. The client 133 may include a mobile phone, a tablet, a laptop, or the like.

In some embodiments, the client 133 is configured to run an IoT application module corresponding to the DUT, and simulate a user terminal of the IoT user. The user terminal may be an actual device used by the IoT user, such as a mobile phone, a tablet, a laptop, or the like. The IoT application module refers to a hardware and software component (e.g., an application) related to the DUT.

The device monitoring and control apparatus 134 is an apparatus for monitoring and controlling devices in the test environment 130. The device monitoring and control apparatus 134 may include a camera, a serial port device, or the like.

Some embodiments of the present disclosure integrate the reasoning capability of a LLM, enabling the system 100 to autonomously determine testing steps and thereby improving the intelligence and automation level of vulnerability detection. At the same time, by simulating real-world IoT usage scenarios, the test environment ensures authenticity and comprehensiveness, allowing for more effective identification of security vulnerabilities in IoT devices.

It should be understood that the system 100 and its modules shown in FIG. 1 may be implemented in various ways.

It should be noted that the above descriptions of the system for IoT vulnerability detection based on LLM-assisted reasoning and its modules are for descriptive convenience only, and do not limit the present disclosure to the scope of the cited embodiments. It is to be understood that for a person skilled in the art, after understanding the principle of the system, it may be possible to arbitrarily combine individual modules or form a subsystem to connect with other modules without departing from this principle.

In some embodiments, the test module 121 may connect to various elements in the test environment 130 through different utility classes to facilitate information retrieval and instruction execution. Acting as an intermediary between the test environment and the LLM, the test module 121 is configured to execute an instruction selected by the LLM and returning an execution result and a change in the test environment 130 to the LLM.

In some embodiments, the information may include network traffic within the test environment 130, or the like.

In some embodiments, the instruction may include controlling a firewall behavior of the lower-layer router 131, capturing network traffic in the test environment 130, controlling the IoT device 132, monitoring a real-time state of IoT device 132, or the like.

The execution result of an instruction refers to an outcome obtained by the test module 121 after executing the instruction selected by the LLM. For example, the execution result may include the monitored real-time state of the IoT device 132, whether the instruction was successfully executed, or the like.

A utility class refers to a code module or a library with specific functions, designed to interact with various elements in the test environment 130. The utility classes typically provide unified interfaces, simplifying communication and operations with different elements (e.g., a database, a network service, an operating system, etc.), thereby enabling the test module to retrieve the information or issue the instructions more conveniently.

In some embodiments, the utility classes may include one or more of the following: a firewall control utility class, a traffic analysis utility class, an android debug bridge (ADB) utility class, a device control utility class, and a device monitoring utility class.

In some embodiments, the firewall control utility class is configured to manage and control a firewall behavior in the test environment 130. The firewall behavior may include allowing traffic (Allow), filtering traffic (Filter), logging (Log), simulating packet loss (Packet Loss), simulating bandwidth throttling (Bandwidth Throttling), or the like. Network states may include a normal state, a high latency state, a high packet loss state, a bandwidth-limited state, a fully blocked state, a partially blocked state, an attack simulation state, etc.

In some embodiments, the traffic analysis utility class is configured to monitor, capture, and analyze network traffic between the test module 121 and the test environment 130.

In some embodiments, the ADB utility class is configured to debug and communicate with an end-user device (e.g., the client or the user terminal). States of the user terminal may include device information, a network state, an operational state, etc.

In some embodiments, the device control utility class is configured to manage and control the IoT device 132 in the test environment 130. Through the device control utility class, the test module 121 may start, stop, restart, or configure the IoT device to meet testing requirements.

In some embodiments, the device monitoring utility class is configured to monitor the IoT device in the test environment 130 in real time. Through the device monitoring utility class, the test module 121 may obtain resource usage metrics such as CPU, memory, and network consumption of the IoT devices, thereby aiding test result evaluation.

In some embodiments, the test module 121 may connect to the test environment 130 via three channels and five utility classes. The three channels include: a connection channel between the lower-layer router 131 and the IoT device 132, a connection channel between the lower-layer router 131 and the client 133, and a connection channel between the lower-layer router 131 and the device monitoring and control apparatus 134.

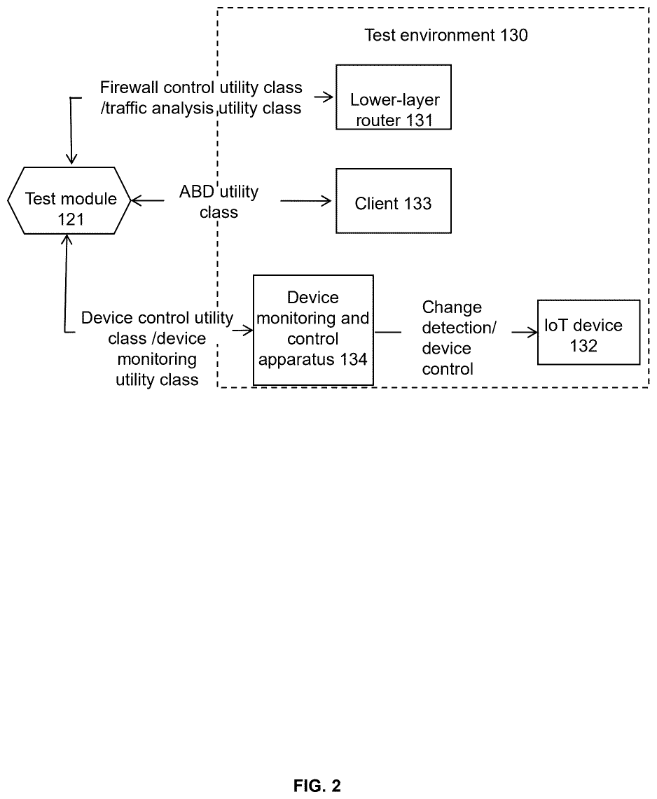

FIG. 2 is a schematic diagram illustrating connections between a test module and a test environment according to some embodiments of the present disclosure.

In some embodiments, as shown in FIG. 2, the test module 121 may connect to the lower-layer router 131 via a firewall control utility class. The firewall control utility class is configured to control a firewall behavior of the lower-layer router 131, such that the test module 130 simulates different network states for the test environment.

In some embodiments, as shown in FIG. 2, the test module 121 may connect to the lower-layer router 131 via a traffic analysis utility class, such that the test module 121 obtains network traffic in the test environment 130 to provide sufficient information for the LLM to analyze a logic vulnerability.

In some embodiments, as shown in FIG. 2, the test module 121 may connect to the client via an ADB utility class, such that the test module 121 provides the LLM with an ability to obtain a state of the user terminal and control the user terminal.

In some embodiments, as shown in FIG. 2, the test module 121 may directly control the IoT device 132 using the device monitoring and control apparatus 134 via a device controlling utility class, such that the test module 121 provides the LLM with an ability to directly control the IoT device 132;

In some embodiments, as shown in FIG. 2, the test module 121 may monitor a real-time state of the IoT device 132 using the device monitoring and control apparatus 134 via a device monitoring utility class, such that the test module 121 provides the LLM with an ability to identify an actual state of the IoT device 132.

Some embodiments of the present disclosure achieve unified management of heterogeneous elements such as the router (e.g., the upper-layer router and the lower-layer router), the client, and the IoT device through the collaboration of the three channels and the five utility classes, addressing the challenge of cross-platform protocol adaptation in traditional test environments and enhancing system compatibility.

Some embodiments of the present disclosure further provide a method for IoT vulnerability detection based on LLM-assisted reasoning. FIG. 3 is a flowchart illustrating an exemplary process for IoT vulnerability detection based on LLM-assisted reasoning according to some embodiments of the present disclosure. As shown in FIG. 3, process 300 includes the following operations. In some embodiments, process 300 may be executed by the test module 121.

In 310, connecting a test module to a test environment.

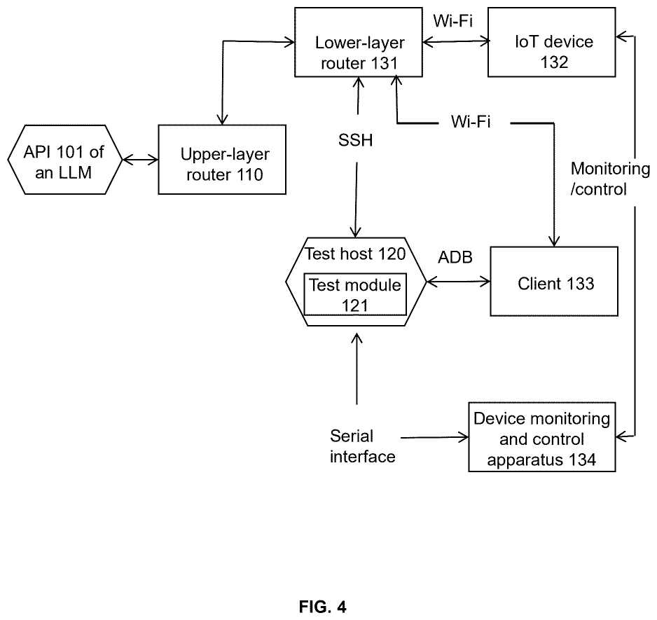

FIG. 4 is a schematic diagram illustrating connections between elements of a system for IoT vulnerability detection based on LLM-assisted reasoning according to some embodiments of the present disclosure.

In some embodiments, as shown in FIG. 4, connecting the test module to the test environment includes: connecting, via the test module 121 running on the test host 120, the test module 121 to the client 133 in the test environment 130 using an ADB utility class; connecting the test module 121 to the lower-layer router 131 in the test environment 130 using a Secure Shell (SSH) client; and connecting the test module 121 to the device monitoring and control apparatus 134 using a serial interface. More descriptions regarding the ADB utility class may be found in FIG. 2 and related descriptions thereof.

SSH is an encrypted network protocol used for secure remote access and management of network devices or servers. The SSH client is a terminal device configured to establish SSH connections.

The serial interface refers to a component that converts parallel data characters received from a CPU into a continuous serial data stream for transmission, and converts received serial data streams into parallel data characters for the CPU. For example, the serial interface may be a USB interface.

In some embodiments, connecting the test module 121 to the test environment includes operations 311-313, which may be executed by the test module 121.

In 311, on the test host 120 running the test module 121, connecting the test module 121 to the client 133 running a corresponding IoT application module using the ADB utility class, such that the test module 121 obtains a state of the client 133 and sends an instruction to the client 133 via the ADB utility class.

The state of the client 133 may include a connection state, an operational state, etc., of the client 133.

In 312, on the test host 120 running the test module 121, connecting the test module 121 to the lower-layer router 131 in the test environment using the SSH client, thereby altering a firewall behavior of a simulated network environment via the test module 121 to simulate a change in the network environment.

The firewall behavior of the simulated network environment may include traffic monitoring and access control, enabling intrusion detection and prevention functions, updating security policies, etc.

The change in the network environment refers to a state variation in the network environment resulting from modifications to the firewall behavior.

In 313, on the test host 120 running the test module 121, use a script module to connect the test module 121 to the device monitoring and control apparatus 134 via the serial interface, thereby enabling the test module 121 to obtain and modify a state of an IoT device under test (DUT).

The script module is configured to establish a connection between the test module 121 and the device monitoring and control apparatus 134 via the serial interface. The script module is preconfigured with serial interface parameters (e.g., baud rate, data bits, stop bits, parity bits, etc.) to ensure proper communication with the device monitoring and control apparatus 134. The test module 121 may communicate with the IoT device 132 through the script module.

The state of the IoT DUT 132 may include a connection state, an operational state, etc. of the IoT DUT 132. In some embodiments, the test module 121 may obtain or modify the state of the IoT DUT 132 via the script module.

Some embodiments of the present disclosure employ a three-channel parallel control mechanism (ADB+SSH+serial interface) to reduce execution time for complex test scenarios and improve testing efficiency. In some embodiments, this three-tier architecture (ADB+SSH+serial interface) enables precise fault localization (APP/network/device), thereby reducing troubleshooting time.

In 320, defining a security attribute for testing based on a test objective.

In some embodiments, before testing begins, the test objective is determined, and the test module 121 may describe the test objective and the security attribute in a natural language.

The test objective refers to an intended detection outcome of the method for IoT vulnerability detection based on LLM-assisted reasoning.

In some embodiments, test objective may include a count of detected vulnerabilities, authenticity of the vulnerabilities, effectiveness of the vulnerabilities, etc.

The authenticity of a vulnerability refers to the consistency between a description of the vulnerability and an actual security weakness, i.e., whether the vulnerability actually exists in a target system.

The effectiveness of a vulnerability refers to whether a description of the vulnerability accurately reflects the nature and scope of impact of the vulnerability.

The security attribute refers to a fundamental security requirement that vulnerability detection must satisfy. The security attribute may include confidentiality, integrity, availability, etc. of vulnerability detection.

In 330, designing and synthesizing a prompt for an LLM based on the security attribute.

In some embodiments, designing and synthesizing the prompt for the LLM based on the security attribute includes: generating a runtime prompt based on a prompt template and the security attribute.

More descriptions regarding the LLM may be found in FIG. 1 and related descriptions thereof.

The prompt for the LLM refers to a guiding text used to direct the LLM to generate content in a specific direction or perform a specialized task. The prompt may include a question, an instruction, a request-related text, etc. sent by a user to the LLM.

The prompt template includes a correspondence between the security attribute and the prompt. The prompt template may be preset by a skilled technician based on experience.

In some embodiments, the test module 121 may determine the runtime prompt by looking up the prompt template based on the security attribute.

In some embodiments, designing and synthesizing the prompt for the LLM based on the security attribute includes operations 331-333. Operations 331-333 may be executed by the test module 121.

In 331, preliminarily generating the prompt template by writing and directly concatenating a test environment description, an LLM utility class description, and an LLM output format description based on an overall test objective.

In some embodiments, the overall test objective is IoT vulnerability detection.

The test environment description refers to a textual explanation of the simulated test environment 130 during vulnerability detection. For example, the test environment description may include descriptions of connection states, network states, and operational states of devices such as the lower-layer router 131, the IoT device 132, the client 133, and the device monitoring and control apparatus 134.

The LLM utility class description refers to explanations of necessary utility classes for completing test tasks. The LLM utility class description may include types of the utility classes, functional descriptions for the utility classes, etc.

The LLM output format description specifies format requirements for an output of the LLM. The LLM output format description may include data structures (e.g., JSON, plain text, Markdown), output examples, field meanings and types, explanations of special markers or symbols, etc. of the output of the LLM.

In some embodiments, the test environment description, the LLM utility class description, and the LLM output format description are written in a natural language.

More descriptions of the prompt template may be found in FIG. 3 and related descriptions thereof.

In 332, generating a component of the runtime prompt by writing and directly concatenating a security attribute description and an IoT device condition description based on an actual condition of a runtime environment of a test.

The actual condition of the runtime environment includes the change in the network environment, the firewall behavior of the network environment, connection states of devices in the test environment, etc.

The security attribute description refers to explanations about the security attribute. The security attribute description may include explanations about confidentiality, integrity, and availability of a test system.

The IoT device condition description refers to explanations about conditions of the IoT DUT 132. The IoT device condition description may include descriptions of a connection state, an operational state, etc., of the IoT DUT 132.

The runtime prompt refers to an instruction, a question, or the like directly input to the LLM.

The component of the runtime prompt includes client-provided specific information or instructions, contextual information, dynamic variables (e.g., connection states and network states of devices in the test environment), etc.

In 333, performing concatenation and format conversion between the prompt template and the component of the runtime prompt to generate the runtime prompt input to the LLM.

In some embodiments, the test module 121 may insert the component of the runtime prompt into a placeholder within the prompt template for concatenation. During this process, the component of the runtime prompt and the corresponding placeholder in the template are converted into a same text format and syntax to generate the runtime prompt.

Some embodiments of the present disclosure employ standardized operations such as direct concatenation and format conversion to automate the generation of the runtime prompt from the prompt template, reducing manual efforts required for repetitive content writing. This approach is particularly suitable for scenarios involving batch testing of a plurality of IoT devices. By incorporating the security attribute description and the IoT device condition description (e.g., firmware versions), the generated prompt has contextual awareness, enabling customized vulnerability detection instructions tailored to specific device configurations and thereby improving detection accuracy.

In 340, invoking the LLM via the test module 121 based on the prompt, autonomously executing the testing under guidance of the LLM, and using a log to record an input and an output of the LLM during the testing.

In some embodiments, the input of the LLM may include an execution result of an instruction and a change in the test environment, and the output of the LLM may include a test result. More descriptions of the execution result may be found in FIG. 2 and related descriptions thereof.

The change in the test environment refers to variations of states (e.g., connection states, operational states) of devices within the test environment.

In some embodiments, connecting the test module 121 to the test environment 130 includes operations 341-343. Operations 341-343 may be executed by the test module 121.

In 341, implementing test utility classes in the test module for the API 101 of the LLM, such that the API 101 of the LLM guides the test module 121 to invoke different utility classes according to requirements.

The API 101 of the LLM may invoke different utility classes based on testing needs. In some embodiments, the test module 121 may initialize an API connection within the test utility classes, retrieve a required utility class configuration via the API 101, capture an API response, and perform result validation and logging based on the utility classes.

In 342, implement the test utility classes in the test module 121 to enable the utility classes to perform test actions and record outputs of the test actions, and returning the outputs to the API 101 of the LLM via the test module 121.

A test action refers to an operation performed by the test module 121 under the guidance of the API 101 of the LLM.

The output of a test action includes a test state (e.g., success or failure), an execution time, output data, a state (a network state, an operational state) of the test environment, or the like.

In 343, implement a logging function in the test module 121 to record the input and the output of the LLM during the testing.

The logging function refers to a capability to record all test information generated during the vulnerability detection process. The test information may include debugging information, error information, warning information, or the like.

In some embodiments, the IoT device 132 may be controlled through the corresponding IoT application module. The LLM may automatically invoke utility classes in the test module 121 to execute tests in response to receiving instructions from the IoT device 132, and logging the input and the output of the LLM during the testing. More descriptions of the IoT application module may be found in FIG. 1 and related descriptions thereof. For example, the LLM may perform the following operations S1-S4:

S1: the LLM may invoke the ADB utility class, enabling the test module 121 to retrieve an actual state of the IoT application module running on a user terminal via the ADB utility class. The state is then sent to the LLM, which obtains the current state of the application module upon receiving a return value.

S2: the LLM may invoke the device monitoring utility class, allowing the test module 121 to acquire the actual state of the IoT device through the environmental monitoring apparatus. This state is transmitted to the LLM, which obtains the current actual state of the IoT device upon receiving the return value.

S3: the LLM may invoke the ADB utility class, enabling the test module 121 to control the corresponding IoT application module running on a mobile device via the ADB utility class, thereby controlling a corresponding IoT device. A control result is then returned to the LLM. Thus, the LLM may confirm whether the instruction to control the IoT device was successfully executed.

S4: the LLM may invoke the device monitoring utility class, allowing the test module 121 to obtain the actual state of the IoT device through an environmental monitoring apparatus. The state is sent to the LLM, which learns the current actual state of the IoT device upon receiving a return value.

In some embodiments, by comparing whether the state of the IoT device changed between operations S2 and S4, it may be determined whether the corresponding IoT application module successfully controlled the IoT device under test. The LLM may autonomously judge whether an attribute “The IoT device is controlled through the corresponding application module” is satisfied. If the attribute is not satisfied, a potential security vulnerability may exist, and the LLM may record the test result through the test module 121. Upon completion of all tests, the testing process and results are logged for reference.

Some embodiments of the present disclosure encapsulate complex testing logic through different utility classes, simplifying test instructions. Comprehensively recording the input and the outputs of the LLM facilitates problem tracing and debugging while supporting test result verification.

Autonomously executing the testing under the guidance of the LLM includes executing the testing based on a plurality of test cases generated by the LLM. In some embodiments, the test module 121 may determine the plurality of test cases via the LLM based on test case instructions.

A test case instruction refers to a command input to the LLM to prompt the LLM to generate a corresponding test case. A test case is a test item used for simulated vulnerability detection, designed to verify whether specific vulnerability detection meets expectations.

In some embodiments, the test case instruction includes at least one potential anomalous function item and a global control flow graph. A count of the test cases output by the LLM is positively correlated with a count of the at least one potential anomalous function item.

A potential anomalous function item refers to a functional item that may exhibit an anomaly. A functional item represents a feature contained in an IoT system. For example, the functional item in a smart home IoT system may include remotely controlling the on/off state of lights. In some embodiments, the anomaly may include complete failure of a functional item (e.g., a “turn on” command is issued, but the light fails to activate). The anomaly may also include a slow response time or a dysfunctional control behavior (e.g., a command to set a fan to level 1 wind speed results in the fan activating its oscillation mode instead).

In some embodiments, the test module 121 may determine structural weights of a plurality of nodes based on the global control flow graph; perform testing using a reference test case to identify at least one reference anomalous function item; determine an anomaly likelihood of each of the plurality of nodes based on the at least one reference anomalous function item; and identify one or more potential anomalous function items based on the structural weights and anomaly likelihoods of the plurality of nodes.

A structural weight of a node refers to an indicator reflecting an importance level or influence of the node in the global control flow graph. The more frequently a node is referenced or traversed, the higher the structural weight of the node is.

In some embodiments, for each of the plurality of nodes, the test module 121 may iteratively update a current structural weight of the node based on an initial structural weight of the node until a preset termination condition is met, then output the updated weight of the node. Each iteration includes: for a current node, determining the updated structural weight of the current node via a weighted sum of the structural weights of its downstream node(s) (i.e., node(s) directly pointed to by the current node). The initial structural weight may be preset empirically. The termination condition may include: a count of iterations reaching a predefined threshold, an average change amount in structural weights across all nodes between consecutive iterations falling below a convergence threshold, or the like.

In some embodiments, the test module 121 may compute the updated structural weight of a node using Equation (1):

$${V}_{i}^{′} = p \times {V}_{i} + q \times \sum ( {V}_{k} \times {R}_{ik} ) , \qquad ( 1 )$$

In Equation (1): Vᵢ denotes a current structural weight of an i-th node, Vᵢ′ denotes an updated structural weight of the i-th node, Vₖ denotes structural weight(s) of downstream node(s) k (pointed to by the i-th node), p and q are weight coefficients, which may be preset empirically, k denotes a count of the downstream node(s) (k is an integer greater zero), i denotes node index (i=1, 2, . . . , A, wherein A represents a total count of the nodes in the global control flow graph), Rᵢₖ denotes the value (typically set to 1) of an edge pointing from the i-th node to a k-th node. In some embodiments, the weight coefficient q may be the reciprocal of a count of upstream node(s) pointing to the i-th node.

The reference test case refers to a test case used in preliminary testing before formal testing. In some embodiments, the test module 121 may randomly generate the reference test case through the LLM. In some embodiments, the reference test case may be preset by technical personnel in the field based on experience.

A reference anomalous function item refers to an anomalous function item that is identified as exhibiting anomalies during preliminary testing. In some embodiments, the reference anomalous function item may be obtained by the LLM analyzing the test result corresponding to a preliminary test case.

The anomaly likelihood of a node reflects a probability of the node exhibiting anomalies.

In some embodiments, a reference anomalous function item may include a plurality of nodes (i.e., code blocks). For each reference anomalous function item, each node corresponds to a sub-anomaly likelihood. The sub-anomaly likelihood of a node refers to a probability of the node exhibiting anomalies within a reference anomalous function item. The anomaly likelihood of each node is a sum of at least one sub-anomaly likelihood corresponding to at least one reference function item in which the each node is located.

In some embodiments, for each of the at least one reference anomalous function item, the test module 121 may determine a potential anomaly degree of the reference anomalous function item based on the structural weights and the anomaly likelihoods of the nodes in the reference anomalous function item. The test module 121 may identify one or more reference anomalous function items whose potential anomaly degree(s) exceed a preset threshold as the one or more potential anomalous function items. The preset anomaly degree threshold may be set empirically or according to requirements.

In some embodiments, the test module 121 may calculate the potential anomaly degree of each reference anomalous function item using Equation (2):

$$D = {\sum }_{( i = 1 \to n )} ( {M}_{i} \times {P}_{i} ) , \qquad ( 2 )$$

In Equation (2), D represents the potential anomaly degree of the reference anomalous function item, i denotes the i-th node in the reference anomalous function item, n represents a total count of nodes in the reference anomalous function item, Mi represents the structural weight of the i-th node, Pᵢ represents the anomaly likelihood of the i-th node.

Some embodiments of the present disclosure determine one or more potential anomalous function items by combining the structural weights and the anomaly likelihoods, leveraging the structural weights to focus on the impact of critical nodes while using anomaly data propagation to identify regions with implicit risks. This approach enhances the comprehensiveness and foresight of anomaly detection, optimizes test resource allocation, and reduces oversight gaps.

In some embodiments, for each of nodes in the at least one reference anomalous function item, the test module 121 may determine semantic information of the node through the LLM based on a semantic analysis instruction, determine a semantic weight of the node via a semantic weighting model based on the semantic information of the node, determine at least one sub-anomaly likelihood corresponding to at least one reference function item in which the node is located based on the semantic weight of the node, and determine the anomaly likelihood of the node based on the at least one sub-anomaly likelihood.

The semantic analysis instruction refers to an input command provided to the LLM to generate an analysis instruction for the nodes (i.e., the code blocks). In some embodiments, the semantic analysis instruction includes the global control flow graph.

In some embodiments, the input of the LLM further includes source codes of all code blocks.

The semantic information of a node (i.e., a code block) may include the purpose or functionality of a variable, a function, the code block, etc.

The semantic weight of a node refers to an importance level of the semantic information of the node in business logic. A same code block may have different semantic weights under different functional items.

The semantic weighting model is a model configured to determine the semantic weight of each node. In some embodiments, the semantic weighting model is a machine learning model, such as a self-attention model (e.g., Transformer Encoder).

In some embodiments, an input of the semantic weighting model may include the semantic information of each node in at least one reference anomalous function item. Each input to the semantic weighting model may include the semantic information corresponding to a plurality of nodes of a reference anomalous function item.

In some embodiments, the input of the semantic weighting model further includes basic information of the reference anomalous function item, such as a name of the reference anomalous function item, or the like.

In some embodiments, an output of the semantic weighting model may include the semantic weight of each node. Each output from the semantic weighting model may include the semantic weights corresponding to a plurality of nodes of a reference anomalous function item.

In some embodiments, the semantic weighting model is obtained through a training process based on a large number of first training samples with first labels. In some embodiments, the training process may include: inputting a plurality of first training samples with first labels into an initial semantic weighting model, constructing a loss function based on the first labels and an output of the initial semantic weighting model, iteratively updating parameters of the initial semantic weighting model via gradient descent or other optimization techniques, completing training when a preset condition is met, thereby obtaining a trained semantic weighting model. The preset condition may include that the loss function converges, a count of iterations reaches a threshold, or the like.

Each set of first training samples may include sample semantic information of each node in at least one sample reference anomalous function item. The first label is a sample semantic weight of each node in at least one sample reference anomalous function item. In some embodiments, a plurality of fault injections may be performed respectively on a plurality of code blocks corresponding to a plurality of nodes in a set of first training samples. Based on a ratio of a count of function item anomalies caused by each code block's fault injection to a total count of function item anomalies, the first label corresponding to the set of first training samples is determined. For example, in a large number of fault injection tests, if the total count of function item anomalies is 100, with 30 anomalies caused by fault injections in code block A and 40 anomalies caused by fault injections in code block B, then the semantic weight of code block A is labeled as 30%, and the semantic weight of code block B is labeled as 40%.

In some embodiments, for each of the least one sample reference anomalous function item, the test module may determine the sub-anomaly likelihood of each node in the sample reference anomalous function item based on the semantic weight of the each node.

In some embodiments, for each node in a reference anomalous function item, the test module 121 may directly designate the semantic weight of the each node as the sub-anomaly likelihood of the each node.

In some embodiments, the test module 121 may take a sum of at least one sub-anomaly possibility corresponding to at least one reference function item in which a node is located as the anomaly possibility of the node.

Relying only on graph structure metrics such as in-degree and out-degree may misclassify common nodes (e.g., loop counting variables) with high-frequency execution as important nodes, while ignoring semantically critical nodes (e.g., password authentication functions). In some embodiments, for each node among a plurality of nodes in the reference a reference anomalous function item, the corresponding anomaly likelihood is determined based on a plurality of sub-anomaly likelihoods of the node, which can compensate for the limitations of single-dimensional analysis, thereby enabling more accurate identification of anomalous nodes and consequently improving the precision of predicting potential abnormal functional items.

The global control flow graph refers to a control flow graph that contains all operational processes and procedures in an IoT system.

In some embodiments, the global control flow graph may exist in a sequential form comprising a plurality of control flow graphs (CFGs).

A control flow graph refers to a diagram that reflects the abstract data structure of a single process or program. The control flow graph may graphically depicts all possible execution paths between basic blocks within a single procedure, or reflect real-time execution of the single process.

In some embodiments, the control flow graph includes nodes and edges. A node of the control flow graph refers to a code block (also referred to as a basic block) consisting of continuous codes in the control flow graph. The node of the control flow graph includes a set of instructions to be executed sequentially.

An edge of the control-flow graph refers to a directed edge connecting code blocks where a branching or jumping relationship exists. The edge of the control-flow graph reflects a connection relationship and a direction of data flow between code blocks.

In some embodiments, the sequence form may include a text sequence. The test module 121 may convert a plurality of control flow graphs to the textual sequence using a linearization manner.

In some embodiments, the global control flow graph may be preconfigured by a user, e.g., by constructing the control flow graph when building the IoT system. In some embodiments, the global control flow graph may also be obtained directly from a processor or a storage device in the IoT system.

In some embodiments of the present disclosure, the test cases generated by the LLM exhibit higher specificity. For potentially anomalous functional items, a greater count of test cases can be generated to ensure testing comprehensiveness and reliability.

In some embodiments, the test module 121 may perform a test based on an order of priorities of a plurality of test cases generated by the LLM. In some embodiments, the plurality of test cases corresponding to a potentially anomalous function item have a same priority. A plurality of groups of test cases (each group including a plurality of test cases) corresponding to different potentially anomalous function items have different priorities.

In some embodiments, the test module 121 may obtain the potentially anomalous function items corresponding to the test cases directly from the LLM.

In some embodiments, the priority of a test case may be determined based on a potential anomaly degree of the potentially anomalous function item corresponding to the test case.

The potential anomaly degree reflects the likelihood of an anomaly in a functional item. More descriptions regarding the determination of the potential anomaly degree may be found in the related descriptions above.

In some embodiments, the priority is positively correlated with the potential anomaly degree.

In some implementations, executing high-priority test cases first can quickly expose high-risk issues, reduce risks, optimize resource utilization, and improve testing efficiency.

In 350, analyzing a test result based on the output of the LLM during the testing, verifying authenticity and validity of a vulnerability based on the test result and the log during the testing.

More descriptions regarding the authenticity and validity of the vulnerability may be found in operation 320 and the related descriptions.

It should be noted that the above descriptions of process 300 are only for illustration and explanation and do not limit the scope of the present disclosure. Those skilled in the art may make various modifications and changes to process 300 under the guidance of the present disclosure. However, these modifications and changes still fall within the scope of the present disclosure.

Some embodiments of the present disclosure use the reasoning capability of the LLM to assist in the reasoning, which enables intelligent vulnerability detection, reduces manual intervention, and improves testing efficiency and accuracy.

In some embodiments, the test module 121 may determine at least one true anomalous function item and anomalous data information via the LLM based on the test result; determine an anomaly degree via an anomaly analysis model based on the at least one true anomalous function item and the anomalous data information; and determine a regulating action based on the at least one true anomalous function item and the anomaly degree.

A true anomalous function item refers to a function item that is determined to be truly anomalous after completing a full vulnerability detection process (including operations 310-350).

The anomalous data information refers to data information recorded when anomalies occur. For example, the anomalous data information includes an execution result, a time indicator, resource consumption data, etc., of a function item. The execution result includes a complete failure, a partial function failure, an abnormal return value, abnormal throw information, or the like. The time indicator includes a response time, a completion time, a delay fluctuation, or the like. The resource consumption data includes a CPU usage rate, a memory occupancy rate, or the like.

In some embodiments, the test module 121 may input the test result into the LLM to obtain the at least one true anomalous function item and the anomalous data information output by the LLM.

The anomaly degree of an anomaly refers to a criticality level of detected anomalies. The anomaly degree may be expressed as a numerical value. The larger the value is, the more serious the anomaly is.

The anomaly analysis model refers to a model for determining the anomaly degree. In some embodiments, the anomaly analysis model is a machine learning model, e.g., a neural network model, etc.

In some embodiments, an input of the anomaly analysis model includes the true anomalous function item, the anomalous data information, or the like. An output of the anomaly analysis model includes the anomaly degree, or the like.

In some embodiments, the anomaly analysis model may be obtained through a training process based on a large number of second training samples with second labels. The training process of the anomaly analysis model is similar to the training process of the semantic weight model, and more descriptions may be found in the related descriptions above.

Each set of second training samples includes a sample true anomalous function item and sample anomalous data information. The test module 121 may determine a sample anomaly degree based on an impact scope, a repair time, and a repair complexity when an anomaly actually occurs in a second training samples, and designate the sample anomaly degree as the second label for the second training sample. The sample anomaly degree is positively correlation with the impact scope, the repair time, and the repair complexity.

In some embodiments, the test module 121 may determine the regulating action for each of the at least one true anomalous function item, respectively.

In some embodiments, in response to the anomaly degree being greater than a preset threshold, the test module 121 may control the IoT device to block scheduling instructions from all users for the true anomalous function item. In response to the anomaly degree being lower than the preset threshold, the test module 121 may control the IoT device to block scheduling instructions from ordinary users for the true anomalous function item, and only receive a scheduling instruction from a management user.

The scheduling instruction refers to an instruction for scheduling functional items.

In some embodiments, the preset threshold may be set empirically, and different preset thresholds may be set for different function items.

Some embodiments of the present disclosure determine scheduling instructions based on the true anomalous function item and the anomaly degree, enabling targeted determination of different scheduling instructions to block risk propagation, prevent device malfunctions or system-level failures caused by functional anomalies, and ensure system security.

In some embodiments, the test module 121 may dynamically allocate system resources to edge computing devices running anomalous function items based on the anomaly degree.

In some embodiments, the edge computing devices includes at least one of an embedded controller, a smart terminal, or the like.

In some embodiments, the system resources include at least one of CPU and a memory resource, or the like.

In some embodiments, the higher the anomaly degree of an anomalous function item on an edge computing device is, the less CPU and memory resource are allocated to the edge computing device.

Some embodiments of the present disclosure can limit the computing power occupied by anomalous function items through dynamic allocation of the system resources.

The basic concepts have been described above, and it is apparent to those skilled in the art that the foregoing detailed disclosure is intended as an example only and does not constitute a limitation of the present disclosure. While not expressly stated herein, those skilled in the art may make various modifications, improvements, and amendments to the present disclosure. These modifications, improvements, and amendments are suggested in the present disclosure, so these modifications, improvements, and amendments remain within the spirit and scope of the exemplary embodiments of the present disclosure.

Meanwhile, the present disclosure uses specific words to describe embodiments of the present disclosure. Such as “one embodiment”, “an embodiment”, and/or “some embodiments” mean a feature, structure, or characteristic associated with at least one embodiment of the present disclosure. Accordingly, it should be emphasized and noted that “an embodiment”, “one embodiment” or “an alternative embodiment” referred to two or more times in different locations in the present disclosure do not necessarily refer to the same embodiment. In addition, certain features, structures, or characteristics of one or more embodiments of the present disclosure may be suitably combined.

Additionally, unless expressly stated in the claims, the order of the processing elements and sequences, the use of numerical letters, or the use of other names as described in the present disclosure are not intended to limit the order of the processes and methods of the present disclosure. While some embodiments of the present disclosure that are currently considered useful are discussed in the foregoing disclosure by way of various examples, it should be understood that such details serve only illustrative purposes, and that additional claims are not limited to the disclosed embodiments; rather, the claims are intended to cover all amendments and equivalent combinations that are consistent with the substance and scope of the embodiments of the present disclosure. For example, although the implementation of various elements described above may be embodied in a hardware device, it is also implemented as a software only solution, e.g., an installation on an existing server or mobile device.

Similarly, it should be noted that in order to simplify the presentation of the present disclosure, and thereby aid in the understanding of one or more embodiments of the present disclosure, the foregoing descriptions of embodiments of the present disclosure sometimes combine a variety of features into a single embodiment, a drawing, or descriptions thereof. However, this method of disclosure does not imply that more features are required for the objects of the present disclosure than are mentioned in the claims. Rather, claimed subject matter lies in less than all features of a single foregoing disclosed embodiment.

Some embodiments use numbers describing the number of components and attributes, and it should be understood that such numbers used in the description of embodiments are modified in some examples by modified words “approximately”, “nearly”, or “substantially”. Unless otherwise noted, the terms “about”, “approximate”, and “approximately” indicate that a ±20% variation in the stated number is allowed. Correspondingly, in some embodiments, the numerical parameters used in the present disclosure and claims are approximations, which are subject to change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

For each patent, patent application, patent application disclosure, and other material cited in the present disclosure, such as articles, books, manuals, publications, documents, etc., the entire contents of which are incorporated herein by reference. Historical application documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for Internet of Things (IoT) vulnerability detection based on large language model (LLM)-assisted reasoning, comprising:
connecting a test module to a test environment, including:
connecting, via the test module running on a test host, the test module to a client in the test environment using an Android Debug Bridge (ADB) utility class,
connecting the test module to a lower-layer router in the test environment using a Secure Shell (SSH) client, and
connecting the test module to a device monitoring and control apparatus using a serial interface;
defining a security attribute for testing based on a test objective, including:
determining the test objective before the testing begins, and
describing the test objective for performing the test and the security attribute using a natural language;
designing and synthesizing a prompt for an LLM based on the security attribute, including:
generating a runtime prompt based on a prompt template and the security attribute;
invoking the LLM via the test module based on the prompt, autonomously executing the testing under guidance of the LLM, and using a log to record an input and an output of the LLM during the testing; and
analyzing a test result based on the output of the LLM during the testing, and verifying authenticity and validity of a vulnerability based on the test result and the log during the testing.

2. The method of claim 1, wherein the connecting a test module to a test environment further includes:
on the test host running the test module, connecting the test module to the client running a corresponding IoT application module using the ADB utility class, such that the test module obtains a state of the client and sends an instruction to the client via the ADB utility class;
on the test host running the test module, connecting the test module to the lower-layer router in the test environment using the SSH client, thereby altering a firewall behavior of a simulated network environment via the test module to simulate a change in a network environment; and
on the test host running the test module, using a script module to connect the test module to the device monitoring and control apparatus via the serial interface, thereby enabling the test module to obtain a state of an IoT device and modify the state of the IoT device.

3. The method of claim 1, wherein the designing and synthesizing a prompt for the LLM based on the security attribute further includes:
preliminarily generating the prompt template by writing and directly concatenating a test environment description, an LLM utility class description, and an LLM output format description based on an overall test objective, wherein the overall test objective is IoT vulnerability detection;
generating a component of the runtime prompt by writing and directly concatenating a security attribute description and an IoT device condition description based on an actual condition of a runtime environment of a test; and
performing concatenation and format conversion between the prompt template and the component of the runtime prompt to generate the runtime prompt input to the LLM.

4. The method of claim 1, wherein the invoking the LLM via the test module based on the prompt, autonomously executing the testing under guidance of the LLM, and using a log to record an input and an output of the LLM during the testing includes:
implementing test utility classes in the test module for an Application Programming Interface (API) of the LLM, such that the API of the LLM guides the test module to invoke different utility classes according to requirements;
implementing the test utility classes in the test module to enable the testing utility classes to perform test actions and record outputs of the test actions, and returning the outputs to the API of the LLM via the test module; and
implementing a logging function in the test module to record the input and the output of the LLM during the testing.

5. A system for Internet of Things (IoT) vulnerability detection based on large language model (LLM)-assisted reasoning, comprising:
an upper-layer router configured to provide network connectivity for the system;
a test host configured to run a test module, wherein the test module is configured to:
invoke an API of an LLM over a network to utilize a reasoning capability of the LLM, and
autonomously determine test execution steps based on the reasoning capability of the LLM;
a test environment including a lower-layer router, an IoT device, a client, and a device monitoring and control apparatus, wherein
the lower-layer router is a network control hub and configured to simulate a home environment of an IoT user in a Wi-Fi router, the lower-layer router is connected to the upper-layer router to provide network connectivity and a unified simulated network environment for the IoT device and the client, and the test environment simulates a scenario in which the IoT user uses the IoT device;
the IoT device is a device under test (DUT) and configured to simulate the IoT device of the IoT user; and
the client is configured to run an IoT application module corresponding to the DUT and simulate a user terminal of the IoT user.

6. The system of claim 5, wherein the test module connects to various elements in the test environment through different utility classes to acquire information and issue instructions;
the test module, as an intermediary between the test environment and the LLM, is configured to execute an instruction selected by the LLM and return an execution result of the instruction and a change in the test environment to the LLM;
the test module connects to the test environment via three channels and five utility classes, including:
the test module connecting to the lower-layer router via a firewall control utility class, wherein the firewall control utility class is configured to control a firewall behavior of the lower-layer router, such that the test module simulates different network states for the test environment;
the test module connecting to the upper-layer router via a traffic analysis utility class, such that the test module obtains network traffic in the test environment to provide sufficient information for the LLM to analyze a logic vulnerability;
the test module connecting to the client via an ADB utility class, such that the test module provides the LLM with an ability to obtain a state of the user terminal and control the user terminal;
the test module directly controlling the IoT device using the device monitoring and control apparatus via a device controlling utility class, such that the test module provides the LLM with an ability to directly control the IoT device; and
the test module monitoring a real-time state of the IoT device using the device monitoring and control apparatus via a device monitoring utility class, such that the test module provides the LLM with an ability to identify an actual state of the IoT device.
